(19) United States
(12) Patent Application Publication
(10) Pub. No.: US 2010/0126866 A1
(43) Pub. Date: May 27, 2010

(54) METHODS OF DETERMINING POLYDISPERSITY AND/OR MOLECULAR WEIGHT DISTRIBUTION OF A POLYETHYLENE GLYCOL SAMPLE

(75) Inventors: Jasmin Kemptner, Laakirchen (AT); Martina Marchetti-Deschmann, Vienna (AT); Juergen Siekmann, Vienna (AT); Peter Turecek, Klosterneuburg (AT); Hans-Peter Schwarz, Vienna (AT); Guenter Allmaier, Vienna (AT)

Correspondence Address: MARSHALL, GERSTEIN & BORUN (BAXTER), 233 SOUTH WACKER DRIVE, 6300 SEARS TOWER, CHICAGO, IL, 60606-6357, US

(73) Assignees: BAXTER HEALTHCARE S.A., Glattpark (Opfikon) (CH); BAXTER INTERNATIONAL INC., Deerfield, IL (US); TECHNISCHE UNIVERSITAET WIEN, Wien (AT)

(21) Appl. No.: 12/621,051

(22) Filed: Nov. 18, 2009

Related U.S. Application Data
(60) Provisional application No. 61/115,781, filed on Nov. 18, 2008.

(51) Int. Cl. B01D 59/42

(52) U.S. Cl. 204/550

(57) ABSTRACT

Disclosed herein are methods of determining polydispersity (PDI) and molecular mass distribution (MMD) of reactive PEG samples using mass spectrometry. More specifically, a mass spectrometry method called GEMMA is used to determine PDI and MMD of PEG samples which provides more accurate measurements for high molecular weight PEG samples than prior known MALDI-TOF analysis.

### CROSS REFERENCE TO RELATED APPLICATIONS

This application claims the benefit of U.S. Provisional Application No. 61/115,781, filed Nov. 18, 2008, the disclosure of which is incorporated by reference in its entirety.

### BACKGROUND

In modern society, polymers are implemented in a wide range of applications. One prominent use is their conjugation to peptides and proteins. Synthetic peptides and recombinant proteins are commonly used as potent and specific therapeutic agents, though their unrestricted application is limited by several intrinsic factors, low stability in vivo, and thus short plasma half-life, and immunogenicity. Conjugation of peptide/protein-based drugs with polymers, such as polyethylene glycol (PEG), dextrans, or poly(amino acids), is an increasingly popular strategy to overcome these limitations and facilitate large-scale application of peptide/protein therapies.

Polymers suitable for protein/peptide conjugation have to fulfill a variety of criteria. The polymer should be readily biodegradable to avoid progressive accumulation in the body. Its polydispersity should be as close as possible to one to yield an acceptable homogeneity of the final protein conjugate. Distribution and accumulation in the desired body compartments as well as prolonged action should be given by a sufficient body/compartment-residence time. Finally, the polymer conjugation to the peptide/protein should be obtained via a single reactive group to avoid cross-linking which would provide a inhomogeneous product.

PEG is one of the most prominent polymers used for polymer-drug conjugation due to its outstanding properties. PEG is non-toxic, non-immunogenic, non-antigenic, high solubility in water as well as other solvents, and is accepted by the FDA and EMEA for human use. Its solubility in water and in numerous organic solvents allows pegylation of proteins and/or peptides under mild physiological conditions. Both PEG's flexible chain and ability to bind 2-3 water molecules per ethylene oxide unit contribute to its ability to reduce immunogenicity and antigenicity and to prevent enzymatic degradation of peptides/proteins due to the increased steric hindrance. Another important property concerning the pharmaceutical usage of PEG is the possibility of low polydispersity (PDI), M_{w}/Mₙ, of about 1.01 to about 1.1.

Considering the requirements of a polymer applied for drug conjugation, PEG is a suitable choice. PEG protein conjugates can provide therapeutics having decreased immunogenicity and antigenicity, decreased body-residence time, and increased stability towards metabolic enzymes. While some biological activity may be lost with the PEG conjugate compared to the unmodified protein, often an increased half-life can compensate for this loss. Since the introduction of protein PEGylation in the 1970s, a great number of PEG-drug conjugates have been introduced, e.g. ADAGEN®, NEULASTA®, SOMAVERT®, PEGASYS®, PEG-INTRON®, ONCASPAR®, and more PEG-proteins are currently in clinical trial phases. Further pharmaceutical applications of PEG are conjugation to smaller drugs, like antitumor drugs, peptides, or oligonucleotides and their use as drug delivery systems or diagnostic carriers.

Because drug production is subjected to strict controls, reactive PEG batches applied to drug conjugation have to be evaluated in detail. In general, monomethoxylated PEG (mPEG) is used. mPEG is synthesized by anionic ring opening polymerization initiated with methoxide ions. Due to the presence of trace amounts of water during polymerization, commercially available mPEG can contain a considerable amount of diol PEG (up to 15%), leading to undesired cross-linked co-products and varying degree of coupling groups.

A PEG batch is commonly composed of molecules built up by different numbers of monomers, thus yielding in ideal cases a Gaussian molecular mass distribution (MMD). Possible consequences are drug conjugates with varying biological properties, e.g. body-residence time and/or immunogenicity. To avoid unwanted cross-linked products and to determine the PDI and MMD of a PEG sample, it is recommended to evaluate batches prior to the conjugation process using different analytical techniques, such as chromatography or dynamic light scattering. However, a need exists for other means of assessing the PDI and/or MMD of a PEG sample.

### SUMMARY

Disclosed herein are methods of measuring the PDI and/or the MMD of a PEG sample using gas phase electrophoretic mobility macromolecular analysis (GEMMA). In particular, the methods disclosed herein comprise
a) providing the PEG sample comprising a plurality of PEG polymers of different molecular weights and each PEG polymer comprising a first terminus and a second terminus, and the first terminus comprises a reactive functional group;
b) ionizing the PEG sample to provide a plurality of ions;
c) reducing the plurality of ions to provide neutral or singly charged species;
d) separating the plurality of neutral or singly charged species by an electrophoretic mobility diameter (EMD) of each species using a differential mobility analyzer (DMA); and
e) correlating the EMD of each species to the PDI and/or MMD of the PEG sample.

In some embodiments, the second terminus of the PEG comprises a methoxymethyl group. In various embodiments, the reactive functional group comprises a succinimidyl succinate group. The concentration of the PEG in the sample can be at least about 1 nM or at least about 0.2 mM. In some specific cases, the concentration of the PEG in the sample is about 5 nM to about 100 mM.

Ionizing the of the PEG sample can be by exposing the sample to electrospray ionization. Reducing of the ions can be by exposing the ions to a bipolar atmosphere. In specific cases, the bipolar atmosphere can be generated by a polonium source. The characterizing can be by correlating the EMD of each ion to an EMD of a known molecular weight. The EMD of each ion can be at least about 3 nm. The ions can form unimers, dimers, trimers, or quadramers. In some cases, the ions form trimers and dimers, and both the PDI and MMD of the PEG sample are calculated. In specific cases, the precision of the PDI and/or MMD calculation is at least 5%, or at least 2%.

### BRIEF DESCRIPTION OF THE DRAWINGS

FIG. 1 shows the structure of a PEG-succinimidyl succinate and the calculated molecular weight with number of monomers for various PEG samples.

FIG. 2 shows GEMMA spectra of three PEG samples, where two to three peaks can be observed in each GEMMA spectrum, corresponding to aerosol droplets containing unimers, one singly charged polymer chain, di- or trimers.

FIG. 3 shows GEMMA spectra of various concentrations of mPEG-SS 20K.

FIG. 4 shows shows the MALDI-TOF mass spectra of mPEG-SS 2K prepared by the mentioned techniques (DHB, superDHB and super DHB with NaCl) and acquired in the reflectron mode. The inset of the FIG. 4 shows a small m/z range of the mass spectra in detail with the observable molecular ions and the corresponding different in mass (Δm) values.

FIG. 5 shows MALDI-TOF mass spectra of mPEG-SS 5K, 10K and 20K using superDHB containing NaCl.

### DETAILED DESCRIPTION

Disclosed herein are methods of determining the PDI and/or MMD of a PEG sample. The PEG sample is assessed prior to conjugation to a protein or peptide to form a protein conjugate therapeutic. Because such therapeutics typically are strictly controlled or monitored by the various drug administration boards (e.g., FDA and EMDA), such determinations are important to verify suitability of a particular PEG sample for conjugation to a protein or peptide. Typically, suitable PEG samples have a PDI that is close to 1, e.g., about 1.05 to about 1.2, or about 1.05 to about 1.1.

PEG samples typically have a plurality of polymers, i.e., polymers of different molecular weights due to differing numbers of repeating ethylene glycol monomers. Determination of the distribution of the molecular weight of the PEG polymers in the PEG sample provides the MMD of the sample. The PDI of the sample is a measurement of the ratio of the weight average (M_{w}) to the number average molecular weight (Mₙ) of a polymer sample. The M_{w} is a weight average of the mass of a polymer, such that, on average, a randomly selected specific polymer of a polymer sample will have a mass of M_{w}. The Mₙ is a number average mass of a polymer, which is an average of all the molecular weights of all the polymers in a polymer sample.

The PEG samples being analyzed in the disclosed methods typically have a reactive functional group at one terminus. For example, the PEG can have at one terminus a suitable reactive group that allows for its conjugation to a protein or peptide and at the other terminus a non-reactive functional group. A nonreactive functional group is one which is inert under specific reaction conditions. Under coupling conditions of a PEG to a protein and/or peptide, a non-reactive functional group can be, but is not limited to, a methoxy group. Reactive functional groups are functional groups that under specific reaction conditions are capable of forming a conjugate with a protein, peptide, or other molecule of interest. Non-limiting examples of such reactive functional groups include a succinimidyl succinate, and the like.

The PEG samples are analyzed via mass spectrometry using GEMMA. In GEMMA, a sample is ionized. The ionization can be by electrospray ionization, but other known ionization techniques can be used. The ions formed are then reduced to form singly charged ions or neutral species. The ions can be reduced by exposing the ions to a reducing environment, such as a bipolar atmosphere. In some cases, the bipolar atmosphere is from an α-particle source, such as a polonium source. The ions are then separated using a differential mobility analyzer, which separates ions according to their mobility in air. Then, the ions are detected using a condensation particle counter. The electrophoretic mobility diameter (EMD) of each ion can be calculated by using the Millikan equation, which can then be correlated to the ions molecular weight. Typically, such a correlation uses a comparison of the EMD of a molecule of known molecular weight. GEMMA analysis is generally discussed in Allmaier, et al., J. Mass. Spec., 36:1038-1052 (2001).

Because GEMMA analysis uses the EMD of an ion to determine molecular weight, a larger EMD typically provides a more accurate determination. Therefore, in some embodiments, the EMD of the ions are at least 2 nm, or at least 3 nm. The ions can form unimers (one ion), dimers (two ions clustered together), trimers (three ions clustered together), quadramers (four ions clustered together), or higher order structures. Formation of trimers and quadramers typically have larger EMDs and can therefore more easily be detected by the particle counter. Therefore, formation of such structures can allow for more accurate determination of MMD and/or PDI.

Concentration of the PEG in the sample can effect the formation of dimers, trimers, quadramers, etc. The higher the concentration, the more dimers, trimers, and/or quadramers are formed. In some cases, the PEG sample has a PEG concentration of at least 1 nM, at least 2 nM, at least 3 nM, at least 5 nM, at least 10 nM, at least 50 nM, at least 0.1 mM, or at least 0.2 mM.

The precision of the measurement can be determined by methods known in the art. The precision of the PDI and/or MMD measurement can be at least about 5%, at least about 4%, at least about 3%, or at least about 2%.

Strict controls of national and international regulatory agencies force accurate characterization of reactive PEG polymer batches applied for PEGylation in drug production (e.g. recombinant proteins). Due to nonhomogenous final products, the determination of MMD and the polydispersity is especially of great relevance. As disclosed herein, four mPEG-SS batches were analysed via MALDI-TOF MS and GEMMA, two instruments based on different physico-chemical principles. Molecular mass determination via MALDI-TOF MS analysis is based on the determination of the time-of-flight and the correlated m/z values whereas GEMMA analysis acts on the electrophoretic mobility diameter and the derived molecular mass. Obtained maxima of the MMD of the mPEG-SS batches lie within the specifications stated by the company, MMD±10%, no further conclusions on the data quality achieved via GEMMA or MALDI-TOF could be drawn, due to the lack of more detailed product information, e.g. exact MMD maximum achieved by the company. Polydispersity values of 1.02 for mPEG-SS 2K and 1.01 for mPEG-SS 5K, 10K and 20K were calculated from GEMMA as well as MALDI-TOF data, indicating that the mPEG-SS derivatives exhibit a low MMD, and fulfil the desired criteria to be utilized for conjugation to proteins and peptides.

Precision of GEMMA analysis of polymers increases and the precision of MALDI-TOF MS decreases with increasing MMD. Precision decrease of MALDI-TOF MS is based on the decreasing resolution of the TOF mass analyzer. Increasing GEMMA precision is based on the detection of the multimer clusters, containing one to three PEG chains, which yield a relative narrowing of the MMD. Accordingly, for a PEG with a low MMD, more significant data can be obtained utilizing MALDI-TOF MS, whereas for analysis of a PEG with a higher MMD, GEMMA is the more suitable method.

### EXAMPLES

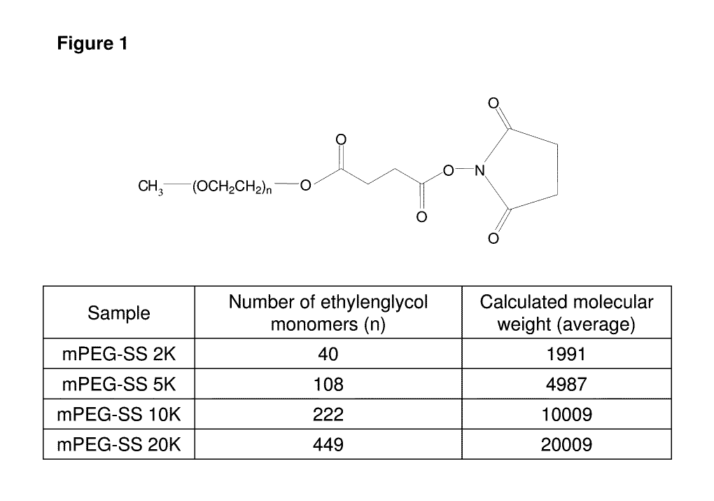

Four monomethoxy PEG-succinimidyl succinate (mPEG-SS) samples, whose structures and calculated exact molecular masses are shown in FIG. 1, were characterized according to MMD and PDI. The EMD of each sample was determined by GEMMA. Multiply charged macromolecular ions were generated via nano electrospray (nES), and charge was reduced by a bipolar atmosphere generated by a polonium source to obtain neutral and singly charged ions. These ions were size separated according to their EMD using a nano differential mobility analyzer (nDMA) and detected by means of a condensation particle counter (μCPC). Based on the correlation of EMD to molecular weight of a known molecule, the MMD of the four mPEG-SS derivatives was determined. To confirm and complement the data achieved with GEMMA, MALDI-TOF MS was applied. Based on the time the accelerated molecule ions need to pass the distance between the ion source and the detector, accurate molecular weight data of the samples was determined.

Chemicals: 2,5-dihydroxybenzoic acid (DHB) and 2-hydroxy-5-methoxybenzoic acid (MSA) were purchased from Sigma-Aldrich (Steinheim, Germany). Sodium chloride, ammonium acetate, ethanol 96% (EtOH) and water p.a (conductivity at 25° C.≦1 μS/cm) were obtained from Merck (Darmstadt, Germany). Four linear PEG samples (methoxy PEG-succinimidyl succinates) dedicated for pharmaceutical applications from SunBio (Anyang City, South Korea) were investigated, namely mPEG-SS 2K, mPEG-SS 5K, mPEG-SS 10K and mPEG-SS 20K.

Sample preparation for MALDI-TOF MS: For MALDI-TOF MS analysis, the PEGs were dissolved in water, to give a concentration of 1 mg/mL for mPEG-SS 2K and 10 mg/mL for mPEG-SS 5K, 10K and 20K. Three matrix systems based on DHB dissolved in water/EtOH (9:1, v/v) were evaluated in terms of best mass spectrometric resolution.

Matrix system A consisted of 10 mg DHB dissolved in 1 mL water/EtOH (9:1, v/v). 2 μL PEG solution and 1 μL matrix solution were directly mixed on the stainless steel MALDI target.
Matrix system B consisted of superDHB, a mixture of DHB and MSA (9:1, w/w) in water/EtOH (9:1, v/v); PEG solution and matrix solution were pre-mixed (1:4, v/v) in an Eppendorf tube and two times 1.5 μL of this mixture were applied onto the target. The spot was recrystallized with 0.8 μL EtOH.
Matrix system C consisted of superDHB (DHB/MSA (9:1, w/w) dissolved in 1 mL water/EtOH (9:1, v/v)) with addition of 0.1 M NaCl solution in a ratio of 1:1 (v/v) related to the PEG concentration.

MALDI-TOF mass spectra of polymer samples were acquired on an AXIMA TOF² (Shimadzu Biotech Kratos Analytical, Manchester, UK) equipped with a nitrogen laser (λ=337 nm). The instrument was operated in positive ion, linear as well as reflectron mode. Each mass spectrum was acquired by averaging 80 to 800 unselected and consecutive laser shots. Prior to data analysis the mass spectra were smoothed with Savitsky-Golay algorithm.

Sample preparation for GEMMA analysis: For GEMMA analysis, all four PEGs were dissolved in ammonium acetate buffer (pH 6.8; 20 mM) to give a concentration of 1 mg/mL. The GEMMA system consists of a nano-electrospray (nES) unit, a nano-differential mobility analyzer (nDMA) and an ultrafine condensation particle counter (μCPC) as detector (all parts from TSI Inc, Shoreview, Minn., USA). Multiply charged ions are generated by the electrospray process and charge reduced to yield neutral and singly charged molecules. The ions were size separated according to their electrophoretic mobility diameter (EMD) in the nDMA and detected with the μCPC. For determination of the PEG size and the derived molecular weight, EMD of several well defined globular standard proteins were determined and used as calibrants. Based on the resulting correlation between EMD and molecular mass of the unknown polymers was characterized. The settings of the nES source were 2 kV and 0.3 L/min CO₂ (99.995%, Air Liquide, Schwechat, Austria)/1 L/min compressed air (99.999% synthetic air, Air Liquide) were applied to operate the instrument in a stable cone-jet mode for the used ammonium acetate buffer (pH 6.8; 20 mM). The inner diameter of the fused silica capillary was 150 nm and the electrospray process was operated in the positive ion mode. Ten scans were averaged for each final size GEMMA spectrum.

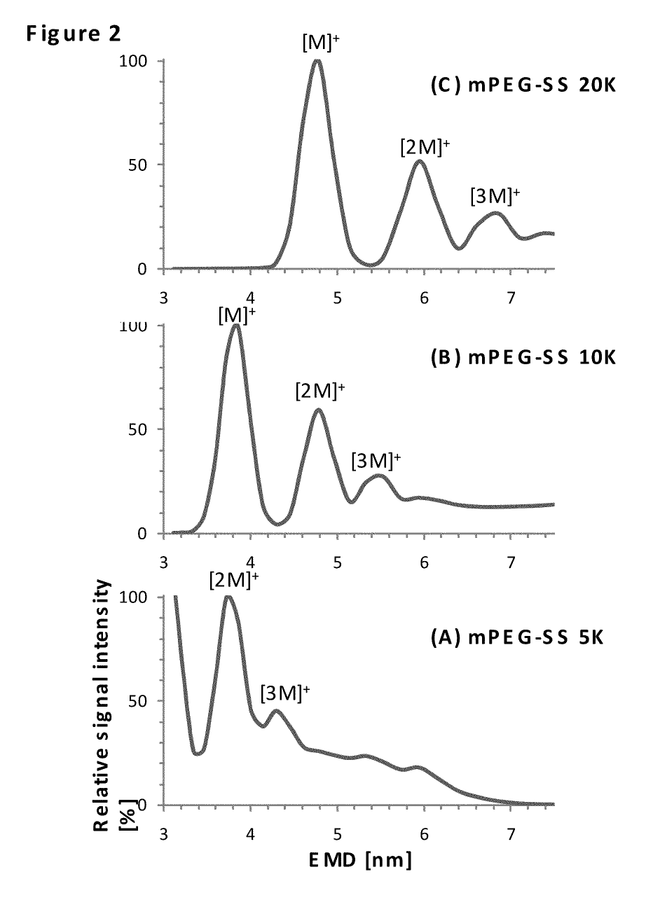

FIG. 2 shows the obtained GEMMA spectra for three of the four investigated PEGs. Two to three peaks can be observed in each GEMMA spectrum, corresponding to aerosol droplets containing unimers, one singly charged polymer chain, di- or trimers, two or three polymer chains building a cluster carrying one charge. All EM diameter values and corresponding maxima of the MMD are summarized in Table 1. Due to the functional limit of the μCPC analyzer at a particle diameter of 3 nm, no GEMMA data could be obtained for mPEG-SS 2K. For the same reason, detection of mPEG-SS 5K unimers was not possible. However, di- and trimers of mPEG-SS 5K were detectable at EM diameters of 3.72 nm and 4.29 nm. The GEMMA spectrum of mPEG-SS 10K exhibited unimers (3.85 nm), as well as di- (4.78 nm) and trimers (5.52 nm). mPEG-SS 20K yielded a unimer with an EM diameter of 4.78 nm, a dimer of 5.94 nm and a trimer of 6.85 nm.

TABLE 1

| | Unimer | | Dimer | | Trimer | |
|---|---|---|---|---|---|---|
| | EMD | MW | EMD | MW | EMD | MW |
| | [nm] | [Da] | [nm] | [Da] | [nm] | [Da] |
| mPEG-SS 5K | — | — | 3.72 | 9100 | 4.29 | 13910 |
| mPEG-SS 10K | 3.85 | 10080 | 4.78 | 19210 | 5.52 | 29540 |
| mPEG-SS 20K | 4.78 | 19210 | 5.94 | 36790 | 6.85 | 56380 |

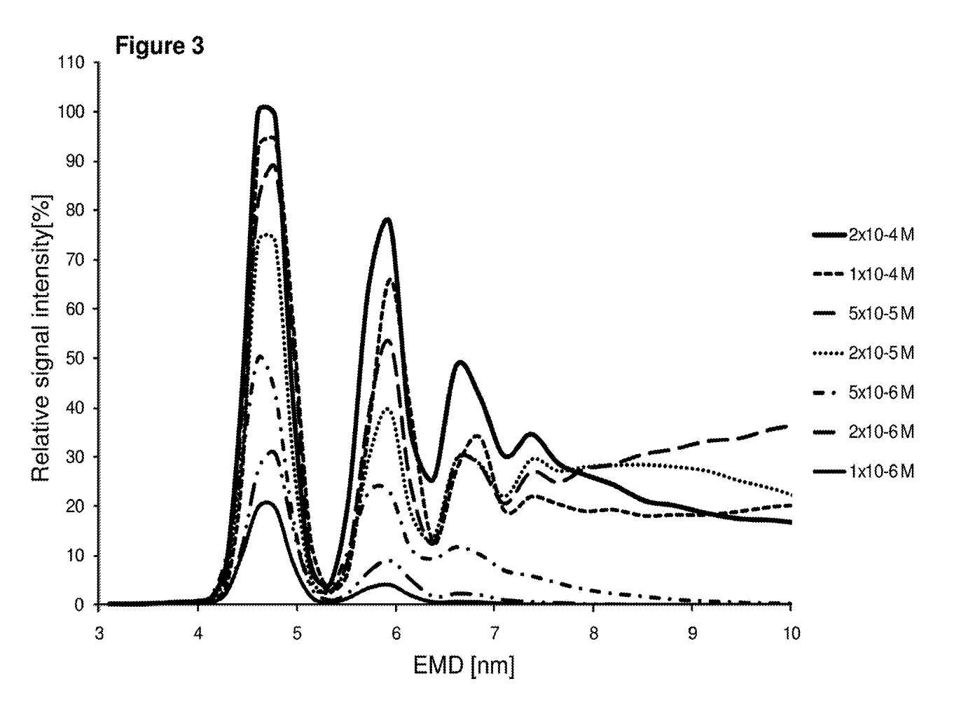

The formation (and its abundance) of dimers and trimers is directly correlated with the sample concentration, which is shown in FIG. 3 exhibiting GEMMA spectra of various concentrations of mPEG-SS 20K. With increasing sample concentration (0.2 mM to 1 nM) not only the unimer, but also the di- and trimer, and at higher concentrations (0.2 mM to 20 nM) even the quadramer, were detected. From concentrations below 1 nM, only the unimer was detected.

For determination of the MMD, the detection of these multimer clusters is desirable, because these clusters contain individual molecules having their own mass distribution, which provide a relative narrowing of the mass distribution. This relative narrowing of the mass distribution obtained by the clustering process can be used to characterize various PEG standards. Based on the formed multimer clusters, the maxima of the MMD were determined, yielding 4.77 kDa for mPEG-SS 5K, 9.76 kDa for mPEG-SS 10K, and 18.70 kDa for mPEG-SS 20K. Precision of the GEMMA analysis increased from mPEG-SS 5K (±4.4%) to mPEG-SS 20K (±1.8%). All MMD maxima data are summarized in Table 2.

TABLE 2
Maximum of molecular mass distribution [Da]

| | Manufacturing | | |
|---|---|---|---|
| | company (based on | | MALDI- |
| | MALDI-TOF MS) | GEMMA | TOF MS |
| mPEG-SS 2K | 2000 (±10%) | not feasible | 2190 (±0.3%) |
| mPEG-SS 5K | 5000 (±10%) | 4770 (±4.4%) | 4870 (±0.6%) |
| mPEG-SS 10K | 10000 (±10%) | 9760 (±2.6%) | 10150 (±0.9%) |
| mPEG-SS 20K | 20000 (±10%) | 18700 (±1.8%) | 19700 (±1.7%) |

Three preparation methods of the matrix DHB, a commonly used MALDI matrix for characterization of PEGs, were evaluated in terms of obtainable MMD and signal intensity. Generally, DHB dissolved in water/EtOH forms long needle shaped crystals resulting in an inhomogeneous distribution of sample and matrix on the target spot. Acquisition of MALDI-TOF mass spectra with high S/N ratio and mass spectrometric resolution is only possible at so called “sweet spots”, where matrix and sample are mixed homogeneously within defined crystal structures. Addition of 10% MSA and/or recrystallization with EtOH helps to overcome the unfavorable crystallization behavior of DHB. In both cases smaller more evenly distributed crystals are formed, thus leading to increased sensitivity and resolution. Recrystallization may also be accompanied by an appreciated side effect, the removal of salt contaminations. In contrast to MALDI-TOF MS of biopolymers, ionization of synthetic polymers occurs mostly via cationization rather than protonation, thus addition of a (inorganic) cationization agent leads to an increase of mass spectrometric sensitivity. Another effect accompanying the use of a cationization agent is the suppression of other salt contaminations present in the polymer sample, matrix or solvents. The consequences of use of the above mentioned matrix additive (MSA), cationization agents and recrystallization on the MALDI-TOF mass spectra of mPEG-SS samples were investigated.

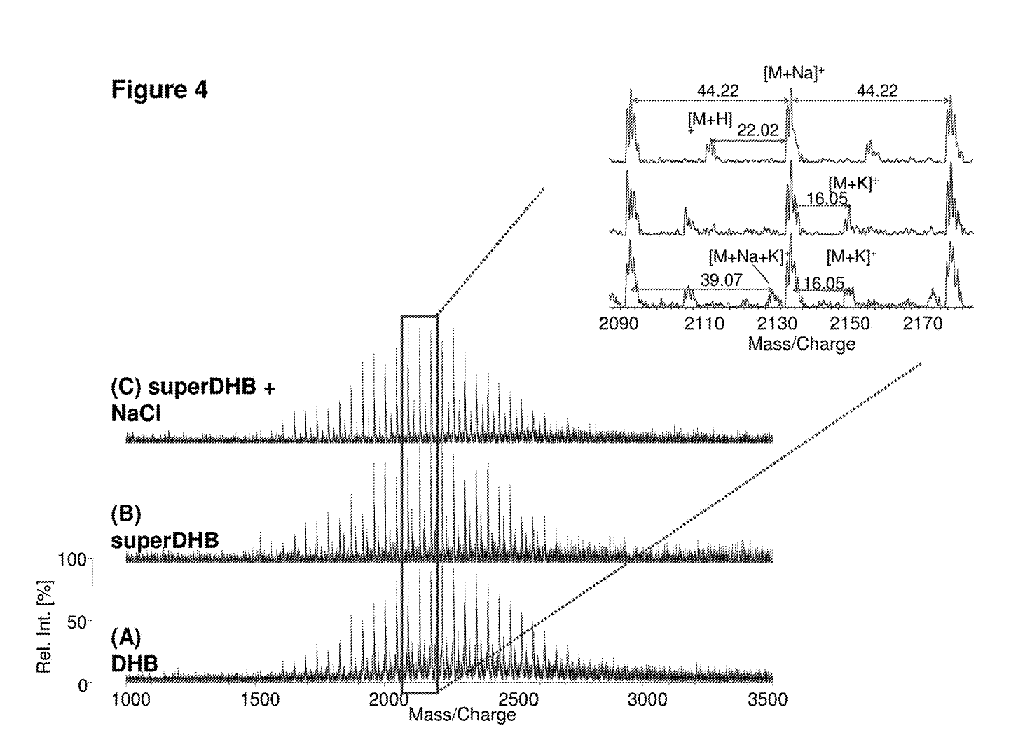

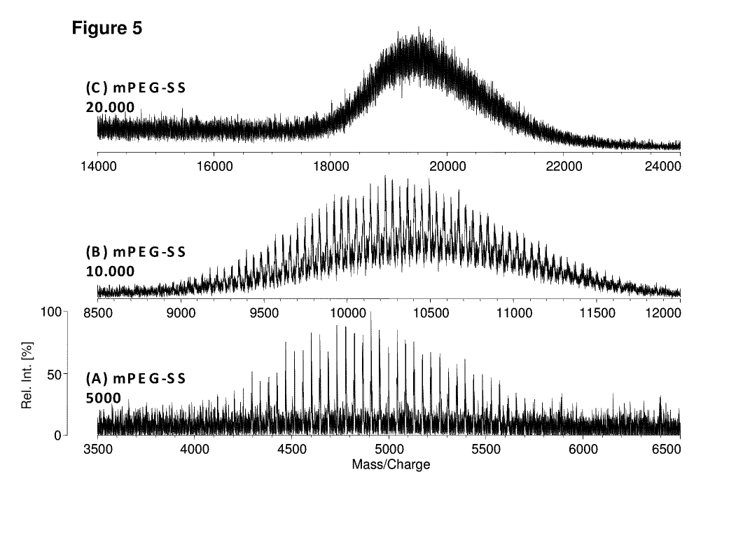

FIG. 4 shows the MALDI-TOF mass spectra of mPEG-SS 2K prepared by the mentioned techniques (DHB, superDHB and super DHB with NaCl) and acquired in the reflectron mode. The inset of the FIG. 4 shows a small m/z range of the mass spectra in detail with the observable molecular ions and the corresponding Δm values. In all three mass spectra, the Na-adduct ions are the most prominent species. Even the plain preparation with DHB without any additives shows 3 groups of ions at 44 Da intervals, respectively Na-adduct ions (most intensive species), K-adduct ions (Δm 38 Da or to the Na-adduct ion Δm 16 Da) and a third signal resulting from [M+Na+K−H]⁺ (Δm 39 Da to the Na-adduct ion). By use of superDHB, also MALDI-TOF mass spectra containing Na (most intensive)- and K-adduct ions were determined, but the third species was not observable. Most likely, this species was removed by recrystallization with EtOH. Third matrix solution was superDHB mixed with NaCl acting as cationization agent. Only now it was possible to determine protonated molecular ions of mPEG-SS 2K, but still the Na-adduct ions were the more prominent peaks, whereas no K-adduct ions could be observed. SuperDHB containing NaCl yields less complex MALDI-TOF mass spectra, showing the protonated molecular ions as well as the still dominating Na-adduct ions. Analysis of the mass spectra showed a MMD from m/z 1477 going up to m/z 2797. SuperDHB containing NaCl was used for MALDI-TOF mass spectrometric analysis of the other polymer samples, mPEG-SS 5K, 10K and 20K. The obtained mass spectra are shown in FIG. 5. The positive ion MALDI mass spectrum of mPEG-SS 5K acquired in the reflectron mode shows a Na-adduct ion distribution starting at m/z 4075 and going up to m/z 5703 with a mass difference of 44 Da between adjacent polymer molecular ions. No K-adducts or protonated molecular ions were observed. Unlike mPEG-SS 2K and 5K, which were analyzed with the reflectron mode, mass spectrum of mPEG-SS 10K was acquired in the linear operation mode, resulting in a series of Na-adduct ions with 44 Da difference.

The molecular ion distribution of the polymer species ranges from m/z 8950 to m/z 11590. MALDI-TOF mass spectrometric analysis of mPEG-SS 20K was also performed in the linear operation mode and yielded a resolved signal starting at m/z 17800 and ending at m/z 21450. In this m/z region the achievable mass spectrometric resolution was not sufficient anymore to resolve the individual molecular ions of the polymer species (which are just 44 Da apart). Table 2 summarizes the maxima of the MMD obtained by MALDI-TOF MS. Following MMD maxima were obtained, for mPEG-SS 2K 2191 Da, mPEG-SS 5K 4870 Da, mPEG-SS 10K 10150 Da and for mPEG-SS 20K 19720 Da. These values differ from the calculated average molecular masses listed in FIG. 1; mPEG-SS 2K yields a difference of +200 Da, mPEG-SS 5K of −118 Da, mPEG-SS 10K of +140 Da and mPEG-SS 20K of −290 Da. Due to decreasing resolution of the TOF mass analyzer, precision of the MALDI-TOF mass spectrometric analysis decreased from mPEG-SS 2K (±0.3%) up to mPEG-SS 20K (±1.7%).

Comparing the maxima of the MMD of the investigated mPEG-SS derivatives, it was observed that the precision of the two methods (GEMMA and MALDI-TOF MS) tend to opposite directions. Precision of GEMMA analysis of polymers increases and the precision of MALDI-TOF MS decreases with increasing MMD. Precision decrease of MALDI-TOF MS is based on the decreasing resolution of the TOF mass analyzer. Increasing GEMMA precision is based on the detection of the multimer clusters, containing one to three PEG chains, which yield a relative narrowing of the MMD. Accordingly, for a PEG with a low MMD more significant data can be obtained utilizing MALDI-TOF MS, whereas for analysis of a PEG having a higher MMD GEMMA is the more suitable method. However, both methods yield MMD maxima lying within the specifications stated by the company, MMD±10%, yielded via MALDI-TOF MS. The MMD data were provided via the product data sheet and information about the applied methods was obtained at www.sunbio.com. Therefore, the MMD maxima obtained by MALDI-TOF MS (2190 Da) lies within the stated specifications of 1800 to 2200 Da for mPEG-SS 2K. As mentioned above, no MMD maximum for mPEG-SS 2K could be obtained via GEMMA analysis, due to the functional limit of the μCPC detector at a particle diameter of 3 nm. MMD maxima of 4770 Da (GEMMA) and 4870 Da (MALDI-TOF MS) for mPEG-SS 5K also fulfill the company's specifications from 3600 to 4400 Da. For mPEG-SS 10K, maxima of 9760 Da for GEMMA analysis and 10150 Da for MALDI-TOF analysis were achieved, perfectly fitting to MMD from 9000 to 11000 Da. Also, MMD maxima acquired for mPEG-SS 20K, 18700 Da (GEMMA) and 19700 (MALDI-TOF MS) were lying within the specifications of 18000 to 22000 Da.

Second parameter for characterization of the mPEG-SS derivatives was the polydispersity, data are summarized in Table 3. Polydispersity stated by the company is based on MALDI-TOF MS data as well as on GPC data, given specifications are 1.05-1.1. Calculation of the polydispersity on basis of MALDI-TOF data was supported by MALDI-MS application software (Shimadzu Biotech Launchpad 2.7, Shimadzu Biotech Kratos Analytical, Manchester, UK), whereas calculation based on GEMMA data was performed by using other equations. For mPEG-SS 2K, polydispersity was only calculated from MALDI data, because no GEMMA data could be achieved due to functional limits of the μCPC (GEMMA detector). MALDI-TOF MS yielded a polydispersity of 1.02. For mPEG-SS 5K, 10K and 20K, polydispersity could be calculated from MALDI-TOF as well as from GEMMA data, yielding a polydispersity of 1.01 consistent through both methods and all experiments. All calculated polydispersity values are in agreement with the company data, they even are lower than the stated limits. So all mPEG-SS samples exhibit a very low MMD indicated by the low polydispersity value.

TABLE 3
Polydispersity

| | Manufacturing company | | |
|---|---|---|---|
| | (based on GPC | | MALDI- |
| | and MALDI-TOF) | GEMMA | TOF MS |
| mPEG-SS 2K | 1.05-1.1 | not feasible | 1.02 |
| mPEG-SS 5K | 1.05-1.1 | 1.01 | 1.01 |
| mPEG-SS 10K | 1.05-1.1 | 1.01 | 1.01 |
| mPEG-SS 20K | 1.05-1.1 | 1.01 | 1.01 |

The foregoing describes and exemplifies the invention but is not intended to limit the invention defined by the claims which follow. All of the methods disclosed and claimed herein can be made and executed without undue experimentation in light of the present disclosure. While the materials and methods of this invention have been described in terms of specific embodiments, it will be apparent to those of skill in the art that variations may be applied to the materials and/or methods and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved.

### REFERENCES

[1] Vicent, et al., Trends in Biotechnology 24 (2006) 39-47.
[2] Khandare, et al., Progress in Polymer Science 31 (2006) 359-397.
[3] Werle, et al., Amino Acids 30 (2006) 351-367.
[4] Shechter, et al., International Journal of Peptide Research and Therapeutics 13 (2006) 105-117.
[5] Abuchowski, et al., The Journal of Biological Chemistry 252 (1977) 3578-3581.
[6] Veronese, et al., Journal of Bioactive and Compatible Polymers 12 (1997) 196-207.
[7] Veronese, et al., Drug Discovery Today 10 (2005) 1451-1458.
[8] Pasut, et al., Advanced Drug Delivery Reviews 60 (2008) 69-78.
[9] Torchilin, et al., Therapeutic Archieves (Russia) 54 (1982) 21-25.
[10] Mehvar, Current Pharmaceutical Biotechnology 4 (2003) 283-302.
[11] Langer, Clinical Lung Cancer 6 Suppl 2 (2004) S85-88.
[12] Pasut, et al., Progress in Polymer Science 32 (2007) 933-961.
[13] Roberts, et al., Advanced Drug Delivery Reviews 54 (2002) 459-476.
[14] Working, et al., in: J. M. Harris, Z. S. (Eds.), Poly(ethylene glycol)Chemistry and Biological Applications, ACS Books, Washington, D.C., 1997, pp. 45-54.
[15] Bailon, et al., Pharmaceutical Science and Technology Today 1 (1998) 352-356.
[16] Caliceti, et al., Advanced Drug Delivery Reviews 55 (2003) 1261-1277.
[17] Katre, Journal of Immunology 144 (1990) 209-213.
[18] Kamisaki, et al., Journal of Pharmacology and Experimental Therapeutics 216 (1981) 410-414.
[19] Nucci, et al., Journal of Free Radicals in Biology and Medicine 2 (1986) 321-325.
[20] Davis, et al., Clinical and Experimental Immunology 46 (1981) 649-652.
[21] Tsuji, et al., International Journal of Immunopharmacology 7 (1985) 725-730.
[22] He, et al., Life Sciences 64 (1999) 1163-1175.
[23] Knauf, et al., The Journal of Biological Chemistry 263 (1988) 15064-15070.
[24] Satake-Ishikawa, et al., Cell Structure and Function 17 (1992) 157-160.
[25] Abuchowski, et al., The Journal of Biological Chemistry 252 (1977) 3582-3586.
[26] Bailon, et al., Bioconjugate Chemistry 12 (2001) 195-202.
[27] Levy, et al., Journal of Pediatrics 113 (1988) 312-317.
[28] Wong, Chemistry of Protein Conjugation and Cross-Linking, CRC Press, Boca Raton, Fla., USA 1991.
[29] Trainer, et al., The New England Journal of Medicine 342 (2000) 1171-1177.
[30] Wang, et al., Advanced Drug Delivery Reviews 54 (2002) 547-570.
[31] Graham, Advanced Drug Delivery Reviews 55 (2003) 1293-1302.
[32] Duncan, et al., Human and Experimental Toxicology 17 (1998) 93-104.
[33] Bonora, Journal of Bioactive and Compatible Polymers 17 (2002) 375-389.
[34] Cammas-Marion, et al., Colloids and Surfaces B: Biointerfaces 16 (1999) 207-215.
[35] Sinha, et al., American Journal of Drug Delivery 2 (2004) 157-171.
[36] Duewell, et al., Investigative radiology 26 (1991) 50-57.
[37] Barth, Advances in Chemistry Series 213 (1986) 31-55.
[38] Nordmeier, Critical Reviews of Optical Science and Technology CR 69 (1997) 43-73.
[39] Kaufman, et al., Analytical Chemistry 68 (1996) 1895-1904.
[40] Saucy, et al., Analytical Chemistry 76 (2004) 1045-1053.
[41] Bacher, et al., Journal of Mass Spectrometry 36 (2001) 1038-1052.
[42] Bahr, et al., Analytical Chemistry 64 (1992) 2866-2869.
[43] Volcker, et al., Macromolecular Chemistry and Physics 200 (1999) 1363-1373.
[44] Jackson, et al., Rapid Communication in Mass Spectrometry 20 (2006) 3542-3550.
[45] Montaudo, et al., Progress in Polymer Science 31 (2006) 277-357.
[46] van Rooij, et al., Journal of American Society of Mass Spectrometry 7 (1996) 449-457.
[47] Karas, et al., Organic Mass Spectrometry 28 (1993) 1476-1481.
[48] Nielen, Mass Spectrometry Reviews 18 (1999) 309-344.
[49] Harvey, Mass Spectrometry Reviews 18 (1999) 349-450.
[50] Rashidzadeh, et al., Rapid Communication in Mass Spectrometry 14 (2000) 439-443.
[51] Shimada, et al., International Journal of Mass Spectrometry 247 (2005) 85-92.

What is claimed:

1. A method of determining a polydispersity of a polyethylene glycol (PEG) sample, comprising
a) providing the PEG sample comprising a plurality of PEG polymers of different molecular weights and each PEG polymer comprising a first terminus and a second terminus, and the first terminus comprises a reactive functional group;
b) ionizing the PEG sample to provide a plurality of ions;
c) reducing the plurality of ions to provide neutral or singly charged species;
d) separating the plurality of neutral or singly charged species by an electrophoretic mobility diameter (EMD) of each species using a differential mobility analyzer (DMA); and
e) correlating the EMD of each species to the polydispersity of the PEG sample.

2. The method of claim 1, wherein the second terminus comprises a methoxy group.

3. The method of claim 1, wherein the reactive functional group comprises a succinimidyl succinate group.

4. The method of claim 1, wherein the ionizing comprises exposing the mixture to electrospray ionization.

5. The method of claim 1, wherein the reducing comprises exposing the neutral or singly charged species to a bipolar atmosphere.

6. The method of claim 5, wherein the bipolar atmosphere is generated by a polonium source.

7. The method of claim 1, wherein the correlating comprises correlating the EMD of each neutral or singly charged species to an EMD of a known molecular weight.

8. The method of claim 1, wherein the EMD of at least one neutral or singly charged species is at least about 3 nm.

9. The method of claim 1, wherein the PEG has a concentration of at least 1 nM in the mixture.

10. The method of claim 9, wherein the PEG has a concentration of at least 0.2 mM in the mixture.

11. The method of claim 1, wherein the neutral or singly charged species form unimers, dimers, trimers, quadramers or combinations thereof.

12. The method of claim 10, wherein the neutral or singly charged species form trimers or quadramers and the correlating further comprises calculating a molecular mass distribution (MMD) of the PEG in the mixture.

13. The method of claim 12, wherein the MMD calculation has a precision within 5%.

14. The method of claim 13, wherein the precision is within 2%.

15. A method of determining a molecular weight distribution of a polyethylene glycol (PEG) sample, comprising
a) providing the PEG sample comprising a plurality of PEG polymers of different molecular weights and each PEG polymer comprising a first terminus and a second terminus, and the first terminus comprises a reactive functional group;
b) ionizing the PEG sample to provide a plurality of ions;
c) reducing the plurality of ions to provide neutral or singly charged species;
d) separating the plurality of neutral or singly charged species by an electrophoretic mobility diameter (EMD) of each species using a differential mobility analyzer (DMA); and
e) correlating the EMD of each species to the molecular weight distribution of the PEG sample.

16. The method of claim 15, wherein the second terminus comprises a methoxy group.

17. The method of claim 15, wherein the reactive functional group comprises a succinimidyl succinate group.

18. The method of claim 15, wherein the ionizing comprises exposing the mixture to electrospray ionization.

19. The method of claim 15, wherein the reducing comprises exposing the neutral or singly charged species to a bipolar atmosphere.

20. The method of claim 19, wherein the bipolar atmosphere is generated by a polonium source.

21. The method of claim 15, wherein the correlating comprises correlating the EMD of each neutral or singly charged species to an EMD of a known molecular weight.

22. The method of claim 15, wherein at least one EMD of the neutral or singly charged species is at least about 3 nm.

23. The method of claim 15, wherein the PEG has a concentration of at least 1 nM in the mixture.

24. The method of claim 23, wherein the PEG has a concentration of at least 0.2 mM in the mixture.

25. The method of claim 15, wherein the neutral or singly charged species form unimers, dimers, trimers, quadramers or combinations thereof.

26. The method of claim 15, wherein the MMD calculation has a precision within 5%.

27. The method of claim 26, wherein the precision is within 2%.
